(19) United States
(12) Patent Application Publication
(10) Pub. No.: US 2020/0298385 A1
(43) Pub. Date: Sep. 24, 2020

(54) PACKING MATERIAL COMPACTION AND EXTRACTION TOOL

(71) Applicants: David McAdam, Calgary (CA); Condor Torres, Grovedale (CA)

(72) Inventors: David McAdam, Calgary (CA); Condor Torres, Grovedale (CA)

(21) Appl. No.: 16/358,069

(22) Filed: Mar. 19, 2019

(51) Int. Cl. B25B 27/00

(52) U.S. Cl. CPC B25B 27/0028

(57) ABSTRACT

A dual-purpose tool configured both for compacting packing material around a rod, pipe, or axle, such as in a stuffing box, and for extracting such packing material. The tool may have a compaction end configured with a packing ram for compressing packing material into a stuffing box, or otherwise compressing the material around a rod. Additionally, the tool may have an extraction end with one or more tapered cleats configured for driving into compacted packing material to loosen and extract the packing material. The dual-purpose tool may be relatively easy to use, comprising two hand-held components that may be nestably positioned on opposing sides of a rod. Each component of the tool may have an elongated semi-circular shape extending between a compaction end and an extraction end. Each component may further have a handle by which a user may manipulate the component to perform packing and extracting operations.

### TECHNOLOGICAL FIELD

The present disclosure relates to tools for handling packing material used in forming a seal around a rod, pipe, or axle. In particular, the present disclosure relates to novel and advantageous tools for compacting and extracting packing material around a rod, pipe, or axle. More particularly, the present disclosure relates to a novel and advantageous dual-purpose tool having a first end configured for compacting packing material and a second end configured for extracting packing material.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In many pumps, valves, and other mechanisms having a rotating or reciprocating rod, pipe, or axle, it may be desirable to form a seal around the moving component to prevent leakage of lubricants or other fluids. A packing material may be positioned and compacted around the rod, pipe, or axle to form a seal. Packing material may include graphite, greased wool, and/or other suitable materials. In some cases, packing material may be held within a stuffing box around the rod, pipe, or axle. For example, in oil and gas operations, an oil well may have a stuffing box arranged at or near the wellhead around the polished rod. Packing material may be arranged in the stuffing box and compacted around the polished rod to prevent fluid leakage. Packing material positioned around a rod, pipe, or axle may require replacement over time. The packing material may break down or tear from use, which may render removal of the material relatively difficult.

In addition to oil and gas operations, compressed packing material may be used to form a seal around a rod, pipe, or axle for other operations, including but not limited to food, boating, manufacturing, other industrial processes, and/or other operations.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a dual purpose packing tool having a first section configured for nesting arrangement around a half-cylindrical side of a polished rod and having a compaction end and an extraction end. The packing tool may additionally have a second section configured for nesting arrangement around a half-cylindrical side of a polished rod and for engagement with the first section around the polished rod and having a compaction end and an extraction end. In some embodiments, the compaction ends of the first and second sections may cooperate to form an annular packing ram for forcing packing into a joint around the polished rod. Moreover, the extractions ends may cooperate to form an extraction tool for extracting packing from the joint. In some embodiments, the extraction end for each section may have at least one cleat, which may have a pointed tip. For each section, the cleat may extend with an included angle of between approximately 20 degrees and approximately 80 degrees, or between approximately 35 degrees and approximately 65 degrees. The cleats may be readily removable. For example, each cleat may each have a threaded stem configured to engage with a threaded opening of the section. In some embodiments, each section may have an elongated portion having a semi-circular cross-sectional shape. At the extraction end, a thumb may extend from the elongated portion and a cleat may extend from an angled surface of the thumb. The angled surface may have an included angle of between approximately 20 degrees and approximately 80 degrees. Each section may have a handle extending laterally outward and configured for a user to grasp the handle. The handles may be readily removable. In some embodiments, each section may have a pair of abutment faces configured to align with abutment faces of the opposing section. At least one section may have a peg extending from an abutment face and configured to engage with a corresponding opening on an abutment face of the opposing section. In some embodiments, the first and second sections may have a same configuration.

The present disclosure, in one or more embodiments, additionally relates to a method of handling packing material surrounding a polished rod. The method may include nestably arranging a first section of a packing tool on a first half-cylindrical side of the polished rod with a compaction end of the section directed toward the packing material and an opposing extraction end of the section directed away from the packing material. The method may further include nestably arranging a second section of the packing tool on a second half-cylindrical side of the polished rod, opposing the first half-cylindrical side, with a compaction end of the section directed toward the packing material and an opposing extraction end of the section directed away from the packing material. The compaction ends of the first and second sections may cooperate to form an annular packing ram for forcing packing material into a joint around the polished rod. The method may further include pushing the first and second sections of the packing tool toward the packing material to compact the packing material into the joint. Each section of the packing tool may include a pair of abutment faces for aligning and engaging with an opposing section of the packing tool. In some embodiments, the packing tool may include a laterally extending handle. The method may further include nestably arranging the first section of the packing tool on the first side of the polished rod with the extraction end of the section directed toward the packing material and the opposing compaction end of the section directed away from the packing material. The method may include nestably arranging the second section of the packing tool on the second side of the polished rod with the extraction end of the section directed toward the packing material and the opposing compaction end of the section directed away from the packing material. The extraction ends may cooperate to form an extraction tool for extracting the packing material from the joint. The method may include twisting the first and second sections of the packing tool in a same direction so as to drive the extraction tool into the packing material and pulling the sections away from the joint to extract the packing material. In some embodiments, each section may include an elongated portion having a semi-circular cross-sectional shape and, at the compaction end, a thumb extending from the elongated portion and a cleat extending from an angled surface of the thumb. The angled surface may have an included angle of between approximately 20 degrees and approximately 80 degrees.

The present disclosure in one or more embodiments, additionally relates to a method of handling packing material surrounding a polished rod. The method may include nestably arranging a first section of a packing tool on a first half-cylindrical side of the polished rod with an extraction end of the section directed toward the packing material and an opposing compaction end of the section directed away from the packing material. The method may include nestably arranging a second section of the packing tool on a second half-cylindrical side of the polished rod, opposing the first half-cylindrical side, with an extraction end of the section directed toward the packing material and an opposing compaction end of the section directed away from the packing material. The extraction ends may cooperate to form an extraction tool for extracting the packing material from the joint. The method may further include twisting the first and second sections of the packing tool in a same direction so as to drive the extraction tool into the packing material. The method may include pulling the first and second sections of the packing tool away from the joint to extract the packing material.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a cross-sectional view of a stuffing box and packing material around a polished rod of an oil well pump, according to one or more embodiments.

FIG. 2 is a side view of a compaction and extraction tool of the present disclosure, according to one or more embodiments.

FIG. 3 is a side view of two components of a compaction and extraction tool of the present disclosure, according to one or more embodiments.

FIG. 4 is an internal view of two components of a compaction and extraction tool of the present disclosure, according to one or more embodiments.

FIG. 5 is an external view of two components of a compaction and extraction tool of the present disclosure, according to one or more embodiments.

FIG. 6 is a close-up view of an extraction end of two components of a compaction and extraction tool of the present disclosure, according to one or more embodiments.

FIG. 7 is a close-up view of an extraction end of a compaction and extraction tool of the present disclosure, according to one or more embodiments.

FIG. 8 is a flow diagram of a method of using a compaction and extraction tool of the present disclosure to compact material, according to one or more embodiments.

FIG. 9 is a flow diagram of a method of using a compaction and extraction tool of the present disclosure to extract material, according to one or more embodiments.

### DETAILED DESCRIPTION

The present disclosure relates to novel and advantageous dual-purpose tools configured both for compacting packing material around a rod, pipe, or axle, such as in a stuffing box, and for extracting such packing material. In particular, a tool of the present disclosure may have a compaction end configured with a packing ram for compressing packing material into a stuffing box, or otherwise compressing the material around a rod. Additionally, a tool of the present disclosure may have an extraction end with one or more tapered cleats configured for driving into compacted packing material to loosen and extract the packing material. The dual-purpose tool of the present disclosure may be relatively easy to use, comprising two hand-held components that may be nestably positioned on opposing sides of a rod. Each component of the tool may have an elongated semi-circular shape extending between a compaction end and an extraction end. Each component may further have a handle by which a user may manipulate the component to perform packing and extracting operations.

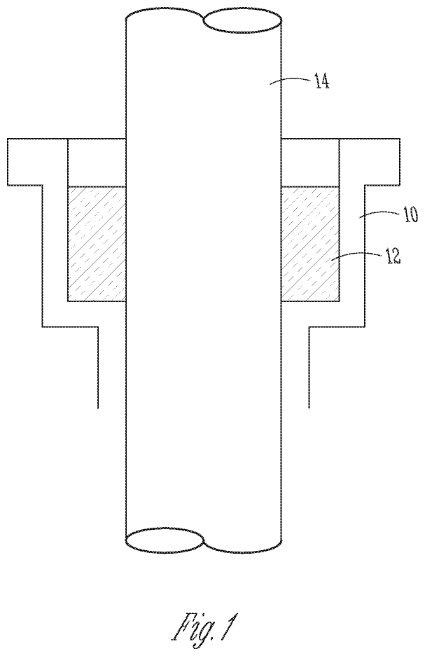

Tools of the present disclosure may be particularly useful in compacting packing material into, and extracting packing material from, a stuffing box. FIG. 1 shows one example of a stuffing box 10 arranged containing packing material 12 positioned around a rod 14. The rod 14 may be, for example, a polished rod of an oil pump. However, the rod 14 may be reciprocating or rotating rod of another process or operation.

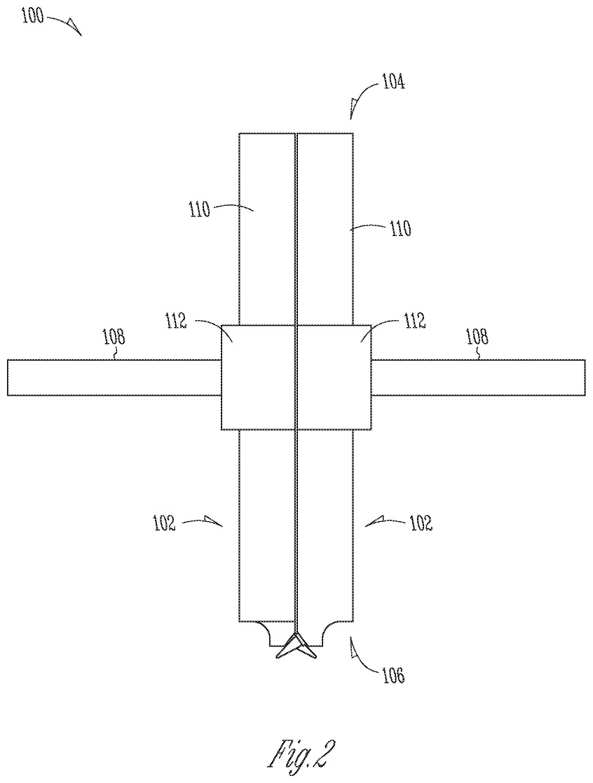

Turning now to FIG. 2, a packing material tool 100 of the present disclosure is shown, according to one or more embodiments. The packing material tool 100 may be configured for handling packing material arranged in a stuffing box around a rod, pipe, or axle. In particular, the tool 100 may be configured for use with graphite, greased wool, or other suitable packing materials. The tool 100 may generally have an elongated tubular shape extending between first and second ends. For example, the tool 100 may have a compaction end 104 shaped and configured for compressing packing material around a rod. Additionally, the tool 100 may have an extraction end 106 shaped and configured for loosening and removing packing material from a stuffing box or from a generally compressed or compacted position about the rod. The tool 100 may have one or more handles 108 for a user to grasp while performing each of the compaction and extraction operations. In some embodiments, the tool 100 may be formed by two components or sections 102, each component forming a half of the tubular-shaped tool and extending between the compaction end 104 and the extraction end 106.

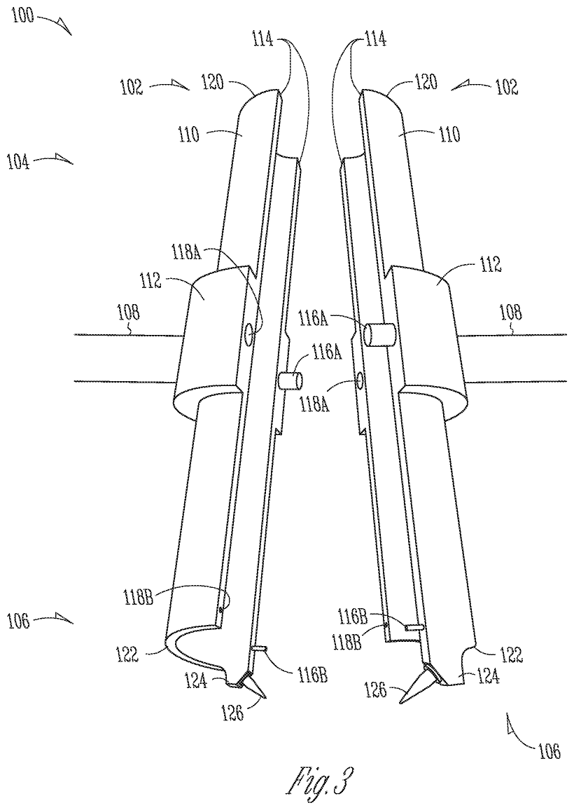

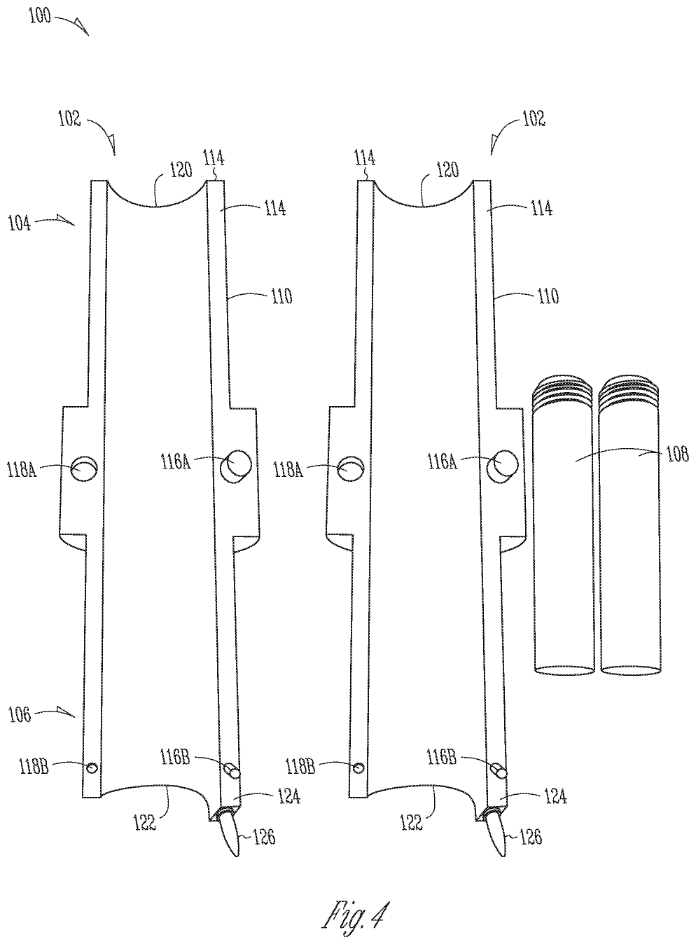

FIGS. 3-5 show the two components 102 of the tool 100. Each section 102 may have an elongated portion 110 extending between compaction 104 and extraction 106 ends. The elongated portion 110 may have a semi-circular cross-sectional shape, such that when the two elongated portions are joined, they together form a tubular member. The elongated portion 110 of each section 102 may be sized to nestably fit around an outer diameter of a rod, such as a drilling rod. For example, the semi-circular shape of the elongated portion 110 may be defined with an inner diameter that is equal to, similar to, or slightly larger than an outer diameter of a polished rod extending through a stuffing box, for example. In some embodiments, each elongated portion 110 may have an inner diameter of between approximately 0.5 inches and approximately 5 inches, or between approximately 1 inch an approximately 3 inches, or between approximately 1.5 inches and approximately 2 inches. In some embodiments, each elongated portion 110 may have an inner diameter of approximately 1.5, 1.6, or 1.7 inches. In still other embodiments, the elongated portion 110 may be defined with any other suitable inner diameter. In some embodiments, the elongated portion 110 may be formed by, or may include, a half pipe section. The elongated portion 110 may have a length of between approximately 5 inches and approximately 20 inches, or between approximately 6.5 inches and approximately 16 inches, or between approximately 8 inches and approximately 12 inches. In some particular embodiments, the elongated portion 110 may have a length of approximately 8 inches, 10 inches, or 12 inches. In other embodiments, the elongated portion 110 may have any other suitable length. Additionally, the elongated portion may have a thickness, between the inner diameter and an outer diameter, of between less than 0.1 inches and approximately 1 inch, or between approximately 0.1 inches and approximately 0.65 inches, or between approximately 0.2 inches and approximately 0.3 inches. In some embodiments, the elongated portion 110 may have a thickness of approximately 0.2 inches or 0.3 inches. In other embodiments, the elongated portion 110 may have any other suitable thickness.

In some embodiments, each elongated section 110 may have a collar portion 112 extending around an outer surface of the section. The collar portion 112 may have a semi-circular shape, such that when the two sections 102 are engaged together, the two collar portions may form a ring. The collar portion 112 may be configured for coupling the handles 108 and/or other components to the elongated portions 110. In particular and as described in more detail below, the collar portion 112 may provide a thickness through which handles 108 and/or other components may be threaded or otherwise coupled to the elongated portions 110. The collar portion 112 may have a length shorter than that of the elongated portion 110, and may be arranged at any suitable location along the length of the elongated portion. In some embodiments, the collar portion 112 may be arranged at, or approximately at, a mid-point of the elongated portion 110. The collar portion 112 may have a thickness of between approximately 0.1 inches and approximately 1 inch, or between approximately 0.2 inches and approximately 0.7 inches, or between approximately 0.3 inches and approximately 0.6 inches. In some embodiments, the collar portion 112 may have a thickness of approximately 0.3, 0.4, or 0.5 inches. In other embodiments, the collar portion 112 may have any other suitable thickness.

The two sections 102 may be configured to align with one another to form the tool 100. For each section 102, a thickness of the elongated portion 110 may form a pair of abutment faces 114 extending along the length of the elongated portion. The abutment faces 114 of one section 102 may be configured to align with opposing abutment faces of an opposing section. In some embodiments, the abutment faces 114 may be relatively smooth. In other embodiments, the abutment faces 114 may have a textured or patterned surface configured to help the section 102 align with an opposing section. In some embodiments, the collar portion 112 may form a portion of the abutment faces 114. That is, at the location of the collar portion 112, the abutment faces 114 may extend outward with a thickness defined by the thickness of the elongated portion 110 together with the thickness of the collar portion.

In some embodiments, the two sections 102 may join together with one or more pegs. For example, one or more pegs 116 may extend from an abutment face 114 of a section 102. In some embodiments, a relatively larger peg 116a may extend from a location along an abutment face 114 as defined by a thickness of the collar portion 112, while a relatively smaller peg 116b may extend from a different location along a length of the abutment face 114. One or both sections 102 of the tool 100 may have one or more pegs 116. One or both sections 102 may additionally have holes 118 configured to receive the corresponding pegs of the opposing section. In some embodiments, the pegs 116 may be removable. The pegs 116 and corresponding holes 118 may allow the two sections 102 to engage one another with a friction fit.

It is to be appreciated that in other embodiments, the sections 102 of the tool 100 may be configured to join or engage one another using additional or alternative means. For example, in some embodiments, the sections 102 may have flanges configured for receiving one or more bolts or screws. In other embodiments, a clamp ring may be positioned around the two sections 102. In some embodiments, a hinge may be arranged between an abutment face 114 of one section 102 and a corresponding abutment face of an opposing section, such that the two sections may hinge open. In still other embodiments, other mechanisms may be used to join the two sections 102 for packing and pulling operations.

As described above, the elongated portion 110 may extend between a compaction end 104 and an extraction end 106. The compaction end 104 may be configured for packing material around a rod or axle in a stuffing box or otherwise in a joint. The compaction end 104 may have a semi-circular edge 120, which may be defined by a thickness of the elongated section 110. The edge 120 may be relatively flat. When the two sections 102 are joined, the two compaction ends 104 of the sections may together form an annular packing ram for compacting packing material in a joint around a polished rod, for example.

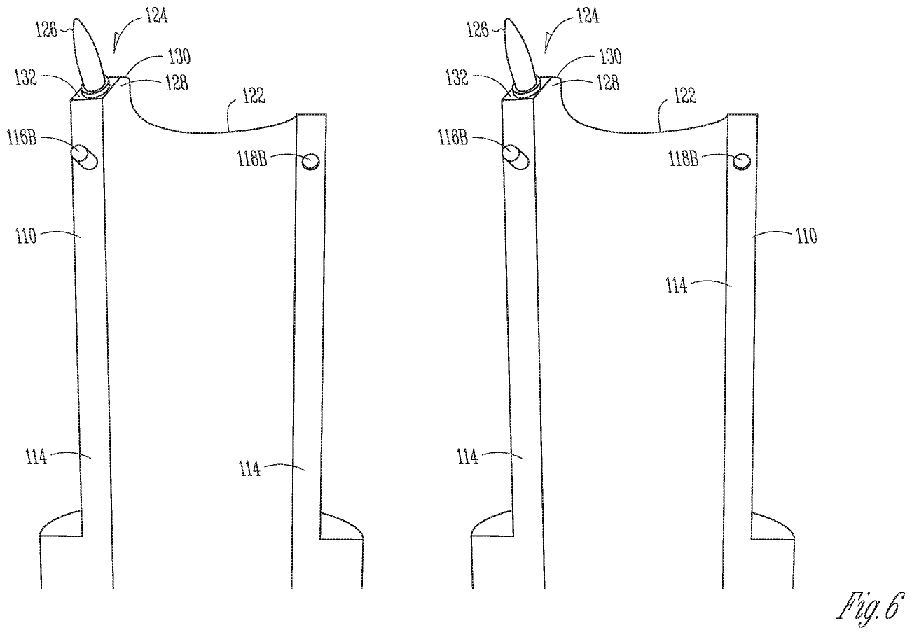

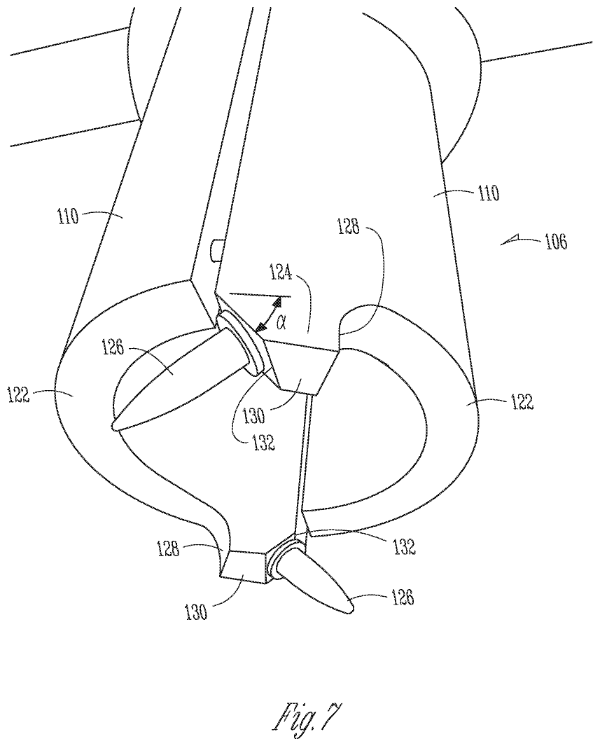

At an end opposing the compaction end 104, each section 102 may have an extraction end 106. The extraction end 106 may be configured for loosening and/or removing packing material from a stuffing box. In particular, the extraction end 106 may be configured for catching or grabbing packing material and pulling the material toward the user. FIGS. 6 and 7 show close up views of the extraction end 106. At the extraction end 106, each section 102 may have a semi-circular edge 122, which may be defined by a thickness of the elongated section 110. Additionally, each section 102 may have a thumb 124 extending from the edge 122 and configured for receiving one or more cleats 126. The thumb 124 may have a thickness that is substantially similar to the thickness of the elongated portion 110. The thumb 124 may extend from the section edge 122 with a length and width suitable for accommodating the at least one cleat 126. In particular, the thumb 124 may have a length and width sized to accommodate an opening in the thumb, the opening configured for receiving a cleat 126, as described in more detail below. In some embodiments, the thumb 124 may have a length and width of between approximately 0.25 inches and approximately 2 inches.

The thumb 124 may be configured so as to position at least one cleat 126 at a desired angle during use. In some embodiments, the thumb 124 may be defined by a first surface 128 extending from the section edge 122. The first surface 128 may extend substantially perpendicular to the section edge 122, or may extend with any other suitable angle. A second surface 130 may extend from the first surface 128 substantially parallel to the section edge 122. A third surface 132 may be an angled surface and may extend between the second surface 130 and the section edge 122 at a desired angle. In some embodiments and as shown in FIG. 7, the angled surface 132 may extend from the section edge 122 with an included angle α of between approximately 20 degrees and approximately 80 degrees from a plane defined by the section edge 122. In some embodiments, the included angle α may be between approximately 35 degrees and approximately 65 degrees, between approximately 45 degrees and approximately 55 degrees, or at an angle of approximately 45 degrees, 50 degrees, or 55 degrees. The at least one cleat 126 may extend from the angled surface 132.

Each cleat 126 may have a length extending from the angled surface 132 of between approximately 0.25 inches and approximately 2 inches, or between approximately 0.5 inches and approximately 1.5 inches. Each cleat 126 may extend to a point or spike at an end opposing the angled surface 132. The point may be relatively narrow or sharp so as to help catch onto compacted packing material. Each cleat 126 may have a round cross-sectional shape with a diameter of less than 1 inch, less than 0.5 inches, or less than 0.25 inches. In other embodiments, the cleats 126 may have any other suitable cross-sectional shape with any other suitable width or diameter.

In some embodiments, the cleat 126 may be permanently or fixedly coupled to the thumb 124. For example, the cleat 126 may be machined with the thumb 124 as a solid component. In other embodiments, the cleat 126 may be affixed to the thumb 124 with an adhesive. In still other embodiments, the cleat 126 may be removably coupled to the thumb 124 so as to be removable and/or replaceable by a user. For example, the thumb 124 may have a threaded opening configured for receiving and engaging with a threaded stem of the cleat 126. In other embodiments, the opening 124 may be configured to engage with a stem of the cleat with a friction fit. In still other embodiments, other removable or non-removable attachment mechanisms may be used. In some embodiments, cleats 126 may be off-the-shelf components. For example, the cleats 126 may be, or may be similar to, athletic shoe cleats.

In some embodiments, each section 102 may have one cleat 126, or each section may have more than one cleat. In some embodiments, only one of the two sections 102 may have one or more cleats 126. In some embodiments, the cleats 126 may be configured at a same angle and pointed in a same rotational direction. For example, as shown in FIG. 7, each of the two angled surfaces 132 may have a same included angle, such that when the sections are joined, the cleats 126 may both point generally in a counter-clockwise direction. In other embodiments, cleats 126 may be arranged with alternating or rotational directions. In still other embodiments, other configurations are envisioned. Moreover, it is to be appreciated that in some embodiments, cleats 126 may be configured to extend directly from the section edge 122, without the thumbs 124.

Referring back to FIGS. 2-5, as indicated above, each section 102 may additionally have a handle 108. Each handle 108 may extend laterally from a point along the length of each elongated portion 110 at an angle of approximately 90 degrees. The handles 108 may extend from approximately a midpoint along the length of each elongated portion 110. In some embodiments, the handles 108 may extend from the collar portions 112. In other embodiments, the handles 108 may extend from a different location along the length of the elongated portions 100. Each handle 108 may have a length of between approximately 1 inch and approximately 7 inches, or between approximately 2 inches and approximately 5.5 inches, or between approximately 3 inches and approximately 4 inches. In some embodiments, each handle 108 may have a length of approximately 3 inches, 3.5 inches, 4 inches, or 4.5 inches. In other embodiments, each handle 108 may have any other suitable length. In some embodiments, the handles 108 may have a tubular shape with a diameter of between approximately 1 inch and approximately 2 inches. In other embodiments, the handles 108 may have any other suitable size and shape. Each handle 108 may be configured to be grasped by a user's hand, such that the user may operate the tool 100 by grasping each handle in one hand.

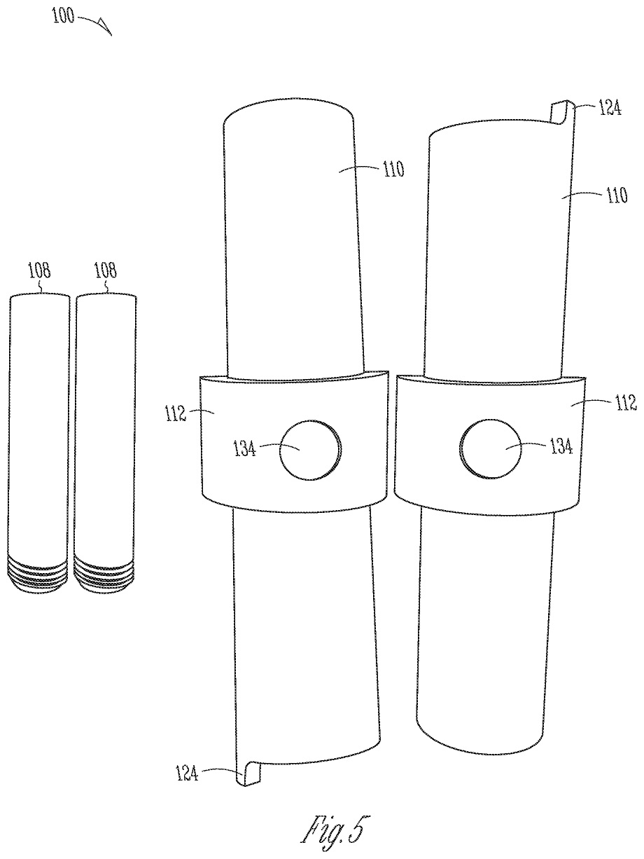

In some embodiments, the handles 108 may be removable. For example, as shown in FIG. 5, each handle 108 may have a threaded end and may be configured to engage with a threaded opening 134 on each collar portion 112. In other embodiments, the handles 108 may be configured to engage with the collar portions 112 or elongated portions 110 by friction fit or by any other suitable coupling mechanism.

Components of the tool 100, including the elongated portions 110, collar portions 112, handles 108, thumbs 124, and cleats 126, may be constructed of steel, carbon steel, or other suitable metals or metal alloys. As indicated above, in some embodiments, the elongated portions 110 may each be constructed with a half-pipe section. Each end of the half-pipe section may be machined to form the compaction end 104 and extraction end 106.

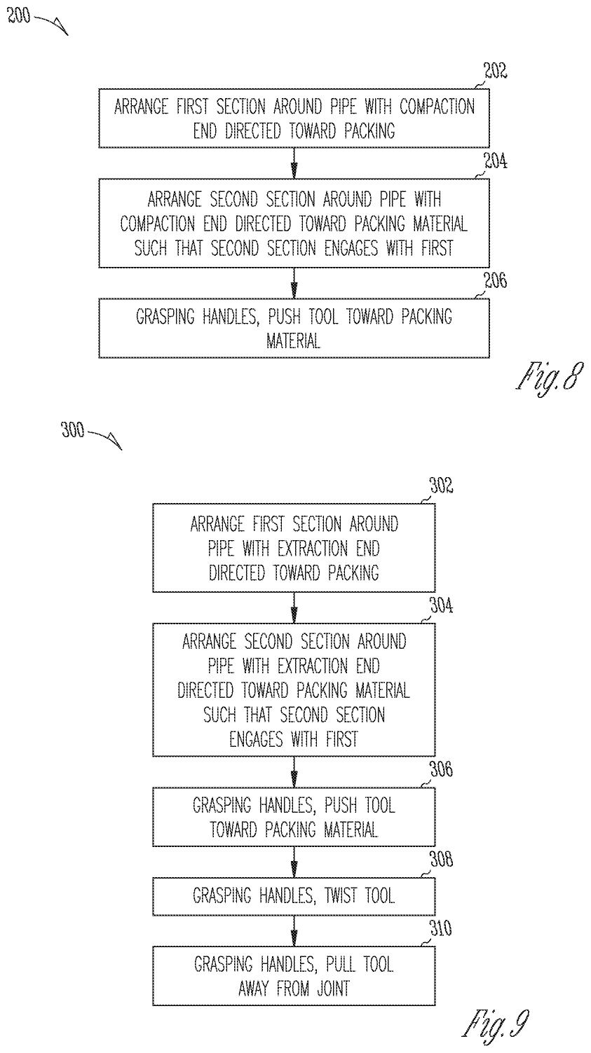

In use, a user may use the compaction end 104 of the tool 100 to compact material around a pipe, rod, or axle at a joint, such as into a stuffing box. FIG. 8 shows one embodiment of a method 200 of using the tool 100 to compact material into such a joint. Packing material around a pipe, rod, or axle in this way may help to seal the joint surrounding the pipe to prevent fluid leakage, for example.

The method 200 may include the steps or arranging a first section of the tool around the pipe with the compaction end directed toward the packing material to be compacted 202. In this way, the first tool section may be nestably positioned around the pipe, rod, or axle about which material is to be compacted. Where the pipe, rod, or axle is arranged generally vertically, the first tool section may also be positioned generally vertically with the compaction end 104 directed generally downward toward the packing material, for example. A user may position the first tool section by grasping the handle of the first section with a first hand. The method 200 may further include arranging a second section around the pipe with the compaction end directed toward the packing material to be compacted, such that the second section engages with the first section 204. In this way, the second section of the tool may be nestably positioned around the pipe on a side opposing the side of the pipe where the first section is nestably positioned. The user may position the second tool section by grasping the handle of the second section with a second hand. The user may generally push or hold the first and second sections together, such that the first and second sections engage one another. For example, in some embodiments, the user may push the first and second sections together around the pipe, such that the pegs 116 of the sections correspond with corresponding holes 118. The method 200 may further include grasping the handles of both sections and pushing the tool toward the packing material to be compacted 206. This may include pushing the tool generally downward into a stuffing box, for example, to compact material into the box. The user may repeatedly push down on the tool, using the compaction end of the tool as a packing ram to force packing material into the joint around the pipe, rod, or axle. In other embodiments, the method 200 may include additional or alternative steps.

In use, the tool 100 may additionally be used to extract or remove packing material. In particular, a user may use the extraction end 106 of the tool 100 to loosen and/or remove material from a joint surrounding a pipe, rod, or axle, such as at a stuffing box. FIG. 9 shows one embodiment of a method 300 of using the tool 100 to remove material. Packing material may need to be loosened for repacking or may need to be replaced, for example.

The method 300 may include arranging a first section of the tool around a pipe with the extraction end directed toward the packing material 302. In this way, the first tool section may be nestably positioned around the pipe, rod, or axle about which material is to be loosened and/or removed. Where the pipe, rod, or axle is arranged generally vertically, the first tool section may also be positioned generally vertically with the extraction end 106 directed generally downward toward the packing material, for example. A user may position the first tool section by grasping the handle of the first section with a first hand. The method 300 may further include arranging a second section around the pipe with the extraction end directed toward the packing material to be loosened and/or removed, such that the second section engages with the first section 304. In this way, the second section of the tool may be nestably positioned around the pipe on a side opposing the side of the pipe where the first section is nestably positioned. The user may position the second tool section by grasping the handle of the second section with a second hand. As described above with respect to the method 200, the user may generally push or hold the first and second sections together, such that the first and second sections engage one another.

The method 300 may further include grasping the handles of the two sections and pushing the tool toward the packing material 306. This may cause the cleats 126 of the tool to drive into the compacted packing material in the joint. The method 300 may further include grasping the handles of the two sections and twisting the tool 308. For example, a user may twist the tool in a direction that causes the cleats 126 to engage with the packing material. Where the cleats 126 are angled to point in a same rotational direction, the user may twist the tool in a same rotational direction so as to drive the cleats further into the compacted material. Where the tool has cleats pointed in differing rotational directions, the user may twist the tool back and forth to cause the cleats to grab onto the compacted material. The twisting or driving of the cleats into the compacted material may generally cause the material to loosen. The method 300 may further include grasping the handles of the two sections and pulling the tool away from the joint 310. With the cleats gripping the packing material, this pulling motion may cause some of the packing material to be pulled away from the joint. In this way, the packing material may be removed. The material may be repositioned for repacking or may be replaced, if desired. In other embodiments, the method 300 may include additional or alternative steps.

Tools and methods of the present disclosure may provide improvements over conventional tools and methods by providing a single compaction and extraction device. That is, rather than requiring a user to maintain separate devices for compacting and extracting material around a pipe, a user may perform both operations using opposing ends of a same tool. Tools of the present disclosure may also be relatively easy to use. For example, packing material may be extracted using a tool of the present disclosure with a twist-pull or push-twist-pull motion. In contrast, some conventional extraction methods and tools may require a user to move a hook or other tool around within the joint to dig out packing material. A tool of the present disclosure may also be more efficient than some conventional packing tools and extracting tools. For example, the pair of cleats at the extraction end may operate to grip compacted packing material more efficiently than conventional hooks or corkscrew-type tools. Tools of the present disclosure may be manufactured using relatively inexpensive components. Moreover, a tool of the present disclosure may have replaceable components and may thus be relatively easy to maintain. If a cleat breaks for example, the cleat may simply be removed and replaced. In addition, a tool of the present disclosure may be operated for compaction and extraction with a relatively low risk of damaging the pipe, rod, or axle about which the packing material is compacted or extracted, as compared with some compaction and extraction methods and tools.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A dual purpose packing tool, comprising:
a first section configured for nesting arrangement around a side of a polished rod and having a compaction end and an extraction end;
a second section configured for nesting arrangement around a side of a polished rod and for engagement with the first section around the polished rod and having a compaction end and an extraction end;
wherein:
the compaction ends of the first and second sections cooperate to form an annular packing ram for forcing packing into a joint around the polished rod; and
the extraction ends cooperate to form an extraction tool for extracting packing from the joint.

2. The packing tool of claim 1, wherein each section comprises, at the extraction end, at least one cleat.

3. The packing tool of claim 2, wherein, for each section, the at least one cleat comprises a pointed tip.

4. The packing tool of claim 2, wherein, for each section, the at least one cleat extends from the section with an included angle of between approximately 20 degrees and approximately 80 degrees.

5. The packing tool of claim 4, wherein, for each section, the at least one cleat extends from the section with an included angle of between approximately 35 degrees and approximately 65 degrees.

6. The packing tool of claim 2, wherein the at least one cleat is readily removable.

7. The packing tool of claim 6, wherein, for each section, the at least one cleat comprises a threaded stem configured to engage with a threaded opening of the section.

8. The packing tool of claim 1, wherein each section comprises an elongated portion having a semi-circular cross-sectional shape.

9. The packing tool of claim 8, wherein each section comprises, at the extraction end, a thumb extending from the elongated portion, and a cleat extending from an angled surface of the thumb, the angled surface having an included angle of between approximately 20 degrees and approximately 80 degrees.

10. The packing tool of claim 1, wherein each section comprises a handle extending laterally outward and configured for a user to grasp the handle.

11. The packing tool of claim 10, wherein the handle of each section is readily removable.

12. The packing tool of claim 1, wherein each section comprises a pair of abutment faces configured to align with abutment faces of the opposing section.

13. The packing tool of claim 12, wherein at least one section comprises a peg extending from an abutment face and configured to engage with a corresponding opening on an abutment face of the opposing section.

14. The packing tool of claim 1, wherein the first and second sections have a same configuration.

15. A method of handling packing material surrounding a polished rod, the method comprising:
nestably arranging a first section of a packing tool on a first side of the polished rod with a compaction end of the section directed toward the packing material and an opposing extraction end of the section directed away from the packing material;
nestably arranging a second section of the packing tool on a second side of the polished rod with a compaction end of the section directed toward the packing material and an opposing extraction end of the section directed away from the packing material, wherein the compaction ends of the first and second sections of the packing tool cooperate to form an annular packing ram for forcing packing into a joint around the polished rod; and
pushing the first and second sections of the packing tool toward the packing material to compact the packing material into the joint.

16. The method of claim 15, wherein each section of the packing tool comprises a pair of abutment faces for aligning and engaging with an opposing section of the packing tool.

17. The method of claim 15, wherein each section of the compaction tool comprises a laterally extending handle.

18. The method of claim 15, further comprising:
nestably arranging the first section of the packing tool on the first side of the polished rod with the extraction end of the section directed toward the packing material and the opposing compaction end of the section directed away from the packing material;
nestably arranging the second section of the packing tool on the second side of the polished rod with the extraction end of the section directed toward the packing material and the opposing compaction end of the section directed away from the packing material, wherein the extraction ends cooperate to form an extraction tool for extracting the packing material from the joint;
twisting the first and second sections of the packing tool in a same direction so as to drive the extraction tool into the packing material; and
pulling the first and section sections of the packing tool away from the joint to extract the packing material.

19. The method of claim 17, wherein each section comprises:
an elongated portion having a semi-circular cross-sectional shape; and
at the compaction end, a thumb extending from the elongated portion, and a cleat extending from an angled surface of the thumb, the angled surface having an included angle of between approximately 20 degrees and approximately 80 degrees.

20. A method of handling packing material surrounding a polished rod, the method comprising:
nestably arranging a first section of a packing tool on a first side of the polished rod with an extraction end of the section directed toward the packing material and an opposing compaction end of the section directed away from the packing material;
nestably arranging a second section of the packing tool on a second side of the polished rod with an extraction end of the section directed toward the packing material and an opposing compaction end of the section directed away from the packing material, wherein the extraction ends cooperate to form an extraction tool for extracting the packing material from the joint;
twisting the first and second sections of the packing tool in a same direction so as to drive the extraction tool into the packing material; and
pulling the first and section sections of the packing tool away from the joint to extract the packing material.
